(19) United States
(12) Patent Application Publication
(10) Pub. No.: US 2025/0174829 A1
(43) Pub. Date: May 29, 2025

(54) RECHARGEABLE BATTERY SEPARATOR

(71) Applicant: Shanghai Double-wonder Energy Technology inc., Shanghai (CN)

(72) Inventors: Haiping FAN, Shanghai (CN); Haiyu ZHAO, Shanghai (CN); Zhenqiu LIU, Northborough, MA (US); Neng YE, Ayer, MA (US); Qunwei WU, Northborough, MA (US)

(21) Appl. No.: 18/540,264

(22) Filed: Dec. 14, 2023

Related U.S. Application Data
(63) Continuation of application No. PCT/CN2023/133555, filed on Nov. 23, 2023.

(51) Int. Cl. H01M 50/446; H01M 10/0525; H01M 50/406; H01M 50/417; H01M 50/431

(52) U.S. Cl. CPC H01M 50/446; H01M 10/0525; H01M 50/406; H01M 50/417; H01M 50/431

(57) ABSTRACT

Lithium ion batteries with separators are disclosed. An example lithium ion battery includes a cathode, an anode, a separator and electrolytes. The cathode releases lithium ions while the lithium ion battery is in a charging mode. The anode releases lithium ions while the lithium ion battery is in a discharging mode. The separator includes one or more pores that transport lithium ions from a first side to a second side in the charging mode, and further transport lithium ions from the second side to the first side in the discharging mode. The electrolytes carry the lithium ions released from the cathode through the separator to the anode in the charging mode, and further carries the lithium ions released from the anode through the separator to the cathode in the discharging mode. The separator includes a mixture of inorganic nanomaterials with polyolefin.

### RELATED APPLICATIONS

This application is a continuation of PCT Application No. PCT/CN2023/133555 filed Nov. 23, 2023, which is incorporated herein by reference, in their entirety, for any purpose.

### BACKGROUND

A lithium ion battery (LiB) is a type of a rechargeable battery that has been popularly used among consumer electronics and electric vehicles. A typical LiB includes a separator between electrodes, such as a cathode and an anode. The separator is a porous membrane that typically has submicron-sized pores that allow movement of lithium ions between the electrodes.

Separators used in commercial LiBs typically include polyolefin microporous membranes, such as dry-processed polypropylene (PP) membranes or wet-processed polyethylene (PE) membranes. PE membranes may be fabricated by wet or phase-inversion processes, in which hydrocarbon liquid (e.g., paraffin oil) is mixed with PE above its melting temperature, and the mixture is pressed into film, and then stretched. By extracting the hydrocarbon liquid with a volatile solvent (e.g., methylene chloride), micropores are formed in the film.

Chemical and electrochemical stability and mechanical durability of a separator are critical to assure safety of the LiB. Commercial separators that include either PE membranes or PP membranes are known to have advantages of low cost, acceptable electrochemical performance and mechanical strength. However, these commercial separators have relatively poor thermal stability at elevated temperatures, because higher temperatures often cause shrinkage of membranes resulting in failure to block the flow of electrons in the LiB during charging and discharging, which may cause a short circuit. When the pores of a separator are partially or totally closed by shrinkage, lithium ions cannot move and may cause a short circuit. At high temperatures, such shrinkage of membranes may cause or fail to prevent an internal electrical short circuit, which leads to failure of the LiB. Thus, separators with higher porosity to achieve higher ionic conductivity together with thermal stability are highly demanded for safer LiB separators, in addition to thermal stability of electrolytes and electrodes.

A variety of separators have been developed to address the poor thermal stability of conventional polyolefin-based separators. For example, a simple method of coating polymers with high thermal resistance or ceramic nanoparticles on a surface of a polyolefin separator have been developed.

### SUMMARY

Examples described herein are directed towards a lithium ion battery and a method for preparing a separator for a lithium ion battery. An example lithium ion battery includes a cathode that releases lithium ions while the lithium ion battery is in a charging mode, an anode that releases lithium ions while the lithium ion battery is in a discharging mode, a separator, and electrolytes. The separator includes one or more pores that transport lithium ions from a first side to a second side in the charging mode, and further transport lithium ions from the second side to the first side in the discharging mode. The electrolytes carry the lithium ions released from the cathode through the separator to the anode in the charging mode, and further carry the lithium ions released from the anode through the separator to the cathode in the discharging mode. The separator includes a mixture of inorganic nanomaterials with polyolefin.

In some examples, the separator includes approximately from 12% to 24% of polyolefin.

In some examples, the polyolefin includes at least one of polyethylene (PE) or polypropylene (PP) or amorphous poly-alpha-olefin (PAO) or a combination thereof.

In some examples, the polyolefin comprises high molecular PE.

In some examples, a range of molecular weight of the high molecular PE is approximately from 5×10⁵ to 3.5×10⁶ (grams/mol).

In some examples, the high molecular PE comprises at least one of extra-high molecular weight PE (UHMWPE), high density PE (HDPE) or low density PE (LDPE).

In some examples, the high molecular PE comprises linear low density PE (LLDPE).

In some examples, the separator includes approximately from 4% to 24% of inorganic nanomaterials or nanoparticles. In some examples, the inorganic nanomaterials include material in a form of an oxide or nitride. In some examples, the inorganic nanomaterials include an oxide or nitride of silicon, aluminum, calcium, titanium, barium, or a combination thereof. In some examples, the inorganic nanomaterials include metal in a form of carbonate or sulfate. In some examples, the metal includes silicon, aluminum, titanium, barium, or a combination thereof. In some examples, a particle size of inorganic nanomaterials is in a range of approximately from 1 nm to 200 nm. In some examples, the particle size of inorganic nanomaterials is in a range of approximately from 1 nm to 100 nm.

In some examples, the mixture of inorganic nanomaterials with polyolefin include titanium oxide.

In some examples, the separator includes a coating layer.

An example method for preparing a separator for a lithium ion battery includes: mixing polyolefin with inorganic nanomaterials in a high-speed dispersing machine to provide first mixture; mixing hydrocarbon liquid into the first mixture to provide a solution; mixing tetrabutyl titanate into the solution to provide third mixture and stirring the third mixture at high speed; and extruding the third mixture into a film.

In some examples, a mass ratio of the polyolefin and inorganic nanomaterials is from 10:1 to 6:1, and said mixing in the high-speed dispersing machine is performed for at least one hour.

In some examples, a mass ratio of the tetrabutyl titanate and the solution is from 1:20 to 1:15, and said stirring the third mixture at high speed is performed for approximately 0.5 hour.

### BRIEF DESCRIPTION OF THE DRAWINGS

FIGS. 1A and 1B are schematic diagrams of a LiB according to an embodiment of the present disclosure.

FIG. 2A is a schematic view of a separator film according to an embodiment of the present disclosure.

FIG. 2B is a comparison table showing characteristics of separators according to an embodiment of the present disclosure.

FIG. 3A is an image of a view of a conventional PE separator for comparison.

FIG. 3B is an image of a view of a separator according to an embodiment of the present disclosure.

FIG. 4 is a flow diagram of methods for fabricating a separator film according to an embodiment of the present disclosure.

FIG. 5 is a schematic view of a calendar machine according to an embodiment of the present disclosure.

### DETAILED DESCRIPTION

Various embodiments of the present disclosure will be explained below in detail with reference to the accompanying drawings. The following detailed description refers to the accompanying drawings that show, by way of illustration, specific aspects and embodiments of the disclosure. The detailed description includes sufficient detail to enable those skilled in the art to practice the embodiments of the disclosure. Other embodiments may be utilized, and structural, logical, and electrical changes may be made without departing from the scope of the present disclosure. The various embodiments disclosed herein are not necessarily mutually exclusive, as some disclosed embodiments can be combined with one or more other disclosed embodiments to form new embodiments. Thus, the following more detailed description of the embodiments of the systems, methods, and apparatuses is not intended to limit the scope of the disclosure, but is merely representative of possible embodiments of the disclosure. In some cases, well-known structures, materials, or operations are not shown or described in detail.

The present disclosure provides various embodiments of a separator, such as a porous membrane film, for LiBs. According to various embodiments, the separator may include a mixture of inorganic nanomaterials with 48.

Various embodiments of the present disclosure will be explained below in detail with reference to the accompanying drawings. The following detailed description refers to the accompanying drawings that show, by way of illustration, specific aspects and embodiments of the disclosure. The detailed description includes sufficient detail to enable those skilled in the art to practice the embodiments of the disclosure. Other embodiments may be utilized, and structural, logical, and electrical changes may be made without departing from the scope of the present disclosure. The various embodiments disclosed herein are not necessary mutually exclusive, as some disclosed embodiments can be combined with one or more other disclosed embodiments to form new embodiments. Thus, the following more detailed description of the embodiments of the systems, methods, and apparatuses is not intended to limit the scope of the disclosure, but is merely representative of possible embodiments of the disclosure. In some cases, well-known structures, materials, or operations are not shown or described in detail.

The present disclosure provides various embodiments of a separator, such as a porous membrane film, for LiBs. According to various embodiments, the separator may include a mixture of inorganic nanomaterials with polyolefin.

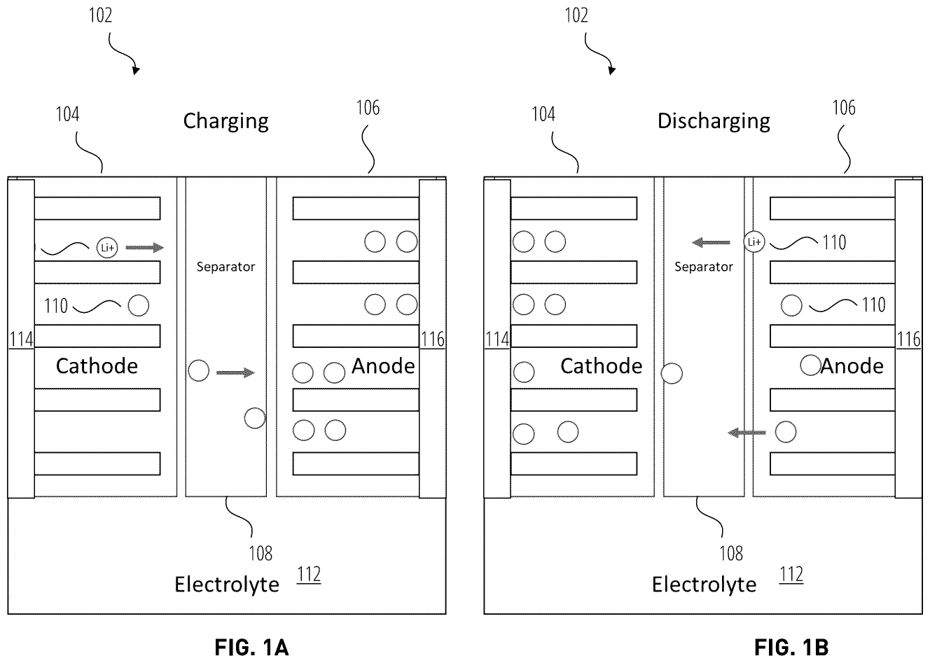

FIG. 1A and FIG. 1B are schematic diagrams that illustrate charge and discharge mechanism of a LiB 102. A LiB 102 includes an anode 106, a cathode 104, a separator 108, electrolytes 112, a positive current collector 114 and a negative current collector 116. The LiB 102 uses a reversible reduction of lithium ions 110 between the cathode 104 and the anode 106. The anode 106 and cathode 104 may store lithium ions 110.

While the LiB 102 is charging (e.g., in a charging mode), as shown in FIG. 1A, lithium ions 110 may be released from the cathode 104. The electrolytes 112 may carry the lithium ions 110 through the separator 108 from the cathode 104 to the anode 106. As the lithium ions 110 move, free electrons may be produced in the anode 106 that cause charges at the positive current collector 114. As a result, an electrical current may flow from the positive current collector 114 through an electric device being powered to the negative current collector 116.

While the LiB 102 is discharging (e.g., in a discharging mode), as shown in FIG. 1B, the LiB 102 may provide an electric current to the electric device. The anode 106 may release lithium ions 110. The released lithium ions 110 may be carried by the electrolytes 112 from the anode 106 to the cathode 104 through the separator 108. As the lithium ions 110 move, free electrons may be produced in the cathode 104 that cause charges at the negative current collector 116. Thus, an electrical current flows from the negative current collector 116.

The separator 108 is a porous membrane that may have submicron-sized pores that allow movement of the lithium ions 110. In some embodiments, separator 108 may prevent short circuits caused by physical contact of the cathode 104 and the anode 106 of the LiB 102. In some examples, the separator 108 may block the flow of electrons inside the LiB 102 during the charging and discharging, while transporting lithium ions 110 formed by or consumed by the reversible reduction reactions.

In some embodiments, the separator 108 may include a mixture of inorganic nanomaterials with polyolefin. In order to enhance the thermal stabilities and porosity of the separator 108, the mass-fraction of the separator 108 may have a composition of materials that may be determined.

In some examples, the composition may include approximately from 12% to 24% of polyolefin. In some examples, the polyolefin may include PE. In some examples, the PE may include extra-high molecular weight PE (UHMWPE), high density PE (HDPE) or low density PE (LDPE). In some embodiments, the PE may include linear low density PE (LLDPE). In some examples, a range of PE molecular weight may be approximately from 5×10⁵ to 3.5×10⁶ (grams/mol). In some examples, the polyolefin may include at least one of polypropylene (PP) or amorphous poly-alpha-olefin (PAO).

In some examples, the composition may include approximately from 4% to 24% of inorganic nanomaterials or nanoparticles. The inorganic nanomaterials may include a metal or non-metal element in a form of an oxide or nitride. For example, the inorganic nanomaterials or nanoparticles may be an oxide or nitride of silicon, aluminum, calcium, titanium, barium, or a combination thereof, etc. In some examples, the inorganic nanomaterials may include a metal element in a form of a carbonate or sulfate. For example, the inorganic nanomaterials or nanoparticles may be a carbonate or sulfate of silicon, aluminum, titanium, barium, or a combination thereof, etc. In some examples, a particle size of inorganic nanomaterials may be in a range of approximately from 1 nm to 200 nm. In some embodiments, the particle size of inorganic nanomaterials may be in a range of approximately from 1 nm to 100 nm.

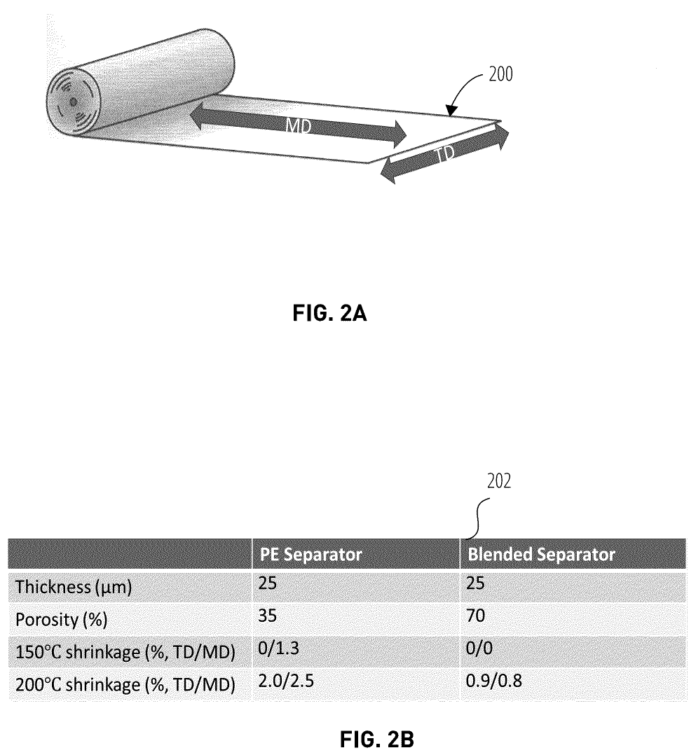

FIG. 2A is a schematic view of a separator film 200 according to an embodiment of the present disclosure. In order to fabricate the separator 108, the film 200 may be fabricated. In some examples, polyolefin may be mixed with inorganic nanomaterials. In some examples, the polyolefin may be PE, PP, or PAO. In some examples, the polyolefin may be a high molecular PE that may include UHMWPE, HDPE or LDPE. In some embodiments, the LDPE may include LLDPE. In some examples, a range of molecular weight of the PE may be approximately from 5×10⁵ to 3.5×10⁶ (grams/mol). In some examples, the molecular weight of the PE may reach around 2 million molecular weight (grams/mol). In some examples, the composition may include approximately from 4% to 24% of inorganic nanomaterials or nanoparticles. The inorganic nanomaterials may include a metal or non-metal element in a form of an oxide or nitride. For example, the inorganic nanomaterials or nanoparticles may be an oxide or nitride of silicon, aluminum, calcium, titanium, barium, or a combination thereof, etc. In some examples, the inorganic nanomaterials may include a metal element in a form of carbonate or sulfate. For example, the inorganic nanomaterials or nanoparticles may be a carbonate or sulfate of silicon, aluminum, titanium, barium, or a combination thereof, etc. In some examples, a particle size of inorganic nanomaterials may be in a range of approximately from 1 nm to 200 nm. In some embodiments, the particle size of inorganic nanomaterials may be in a range of approximately from 1 nm to 100 nm.

Furthermore, hydrocarbon liquid (e.g., paraffin oil) may be mixed into the mixture of polyolefin with inorganic nanomaterials at a higher temperature, such as approximately 200° C. or higher. Once they are mixed thoroughly, the mixture is pressed into a film 200 of FIG. 2A. The film 200 may then be stretched to form a thin layer or membrane. In some examples, the film 200 may be stretched at around 100° C. in a processing machine direction (MD) and in a traverse direction (TD) that is 90 degrees to the MD in a plane defined by the film 200, as shown in FIG. 2A. After stretching the film 200, the hydrocarbon liquid may be removed by applying a chemical material (e.g., dichloromethane). In some examples, the hydrocarbon liquid removal may be performed at room temperature. Thus, pores may be produced after the removal.

FIG. 2B is a comparison table 202 showing characteristics of separators according to an embodiment of the present disclosure. Characteristics of a separator with a mixture of inorganic nanomaterials with polyolefin (blended separator), such as the separator 108 made from the film 200, may be compared with the characteristics of a conventional PE separator (PE separator) including only PE. For comparison purposes, both separators are formed as films having the same thickness of 25 μm.

The conventional PE separator has porosity of approximately 30% to 50%, with an average of 35% as shown in the comparison table 202, whereas the blended separator has bulk porosity of approximately 50% to 80%, with an average of 70% as shown in the comparison table 202. The blended separator has surface porosity of 20% to 50% and internal porosity of 50% to 90%.

Shrinkage was computed in the TD and MD for the PE and blended separators at 150° C. and 200° C. As the table 202 shows, no heat shrinkage of the blended separator was observed at 150° C., whereas heat shrinkage of the conventional PE separator at 150° C. in the MD is 1.3%. At 200° C., heat shrinkages of the blended separator observed are 0.9% and 0.8% in the TD and MD, respectively, whereas heat shrinkages of the conventional PE separator observed are 2.0% and 2.5% in the TD and MD, respectively. From this comparison, reduction of shrinkage in the blended separator may be observed.

Because inorganic nanomaterials or nanoparticles have a melting temperature at or above 1000° C., a size of pores may be stable at or above a melting temperature of polyolefin. Thus, a blended separator having a larger porosity size from 30 nm to 100-200 nm may be obtained.

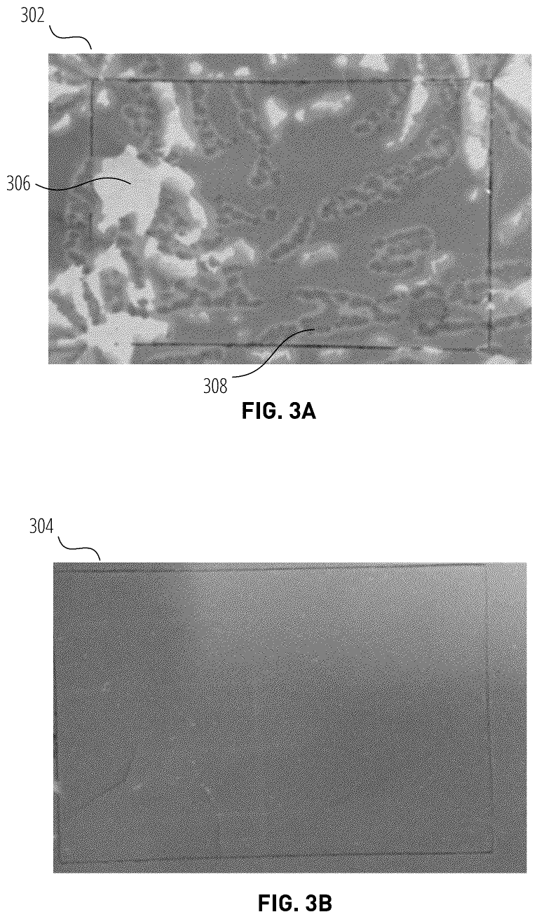

FIG. 3A is an image 302 of a view of a conventional PE separator film for comparison. The conventional PE separator film with a double surface coating of ceramic nanoparticles was heated for an hour at 200° C. FIG. 3B is an image 304 of a view of a separator film according to an embodiment of the present disclosure. The separator film, such as the separator film 200 including the mixture of inorganic nanomaterials with polyolefin was heated for an hour at 200° C. In the image 302, irregular gaps, such as a gap 306, and dense portions with pore closures, such as a dense portion 308, may be observed. On the other hand, the image 304 shows uniform porosity.

In addition to reducing the heat shrinkage and enhancing porosity of the separator, the inorganic nanomaterials are observed to improve structures of the pores and enhance the electrolyte retention capability. Thus, an absorption rate and/or electrolyte uptake increases as well. When a conventional PE separator's pores are closed by shrinkage, absorption of lithium ions, such as the lithium ions 110, through electrolytes, such as the electrolytes 112, from an anode to a cathode, such as the anode 106 to the cathode 104, may be reduced; however, by including inorganic nanomaterials, the blended separator may have a higher absorption speed with a lower electrolyte resistance.

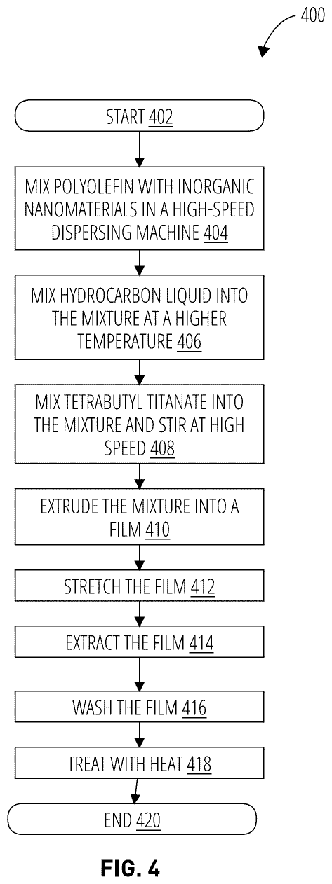

In order to enhance the thermal stabilities and porosity of the separator 108, the mass-fraction of the separator 108 may have a composition of materials that may be determined. In some embodiments, the separator 108 may be fabricated by including the one or more cross-linking and adhesion modifiers, such as tetrabutyl titanate when mixing materials. FIG. 4 is a flow diagram of an example method 400 for fabricating a separator film 200 according to an embodiment of the present disclosure.

In block 402, polyolefin and inorganic nanomaterials may be prepared. In some examples, the polyolefin may be PE, PP, or PAO. In some examples, the polyolefin may be a high molecular PE that may include UHMWPE, HDPE or LDPE. In some embodiments, the high molecular PE may include UHMWPE having a viscosity average molecular weight (Mv) of 1×10⁵ to 3×10⁶ (grams/mol). When the Mv of PE is 1×10⁵ or more, a mechanical strength of a microporous membrane may be appropriate, and when the Mv of PE is 3×10⁶ or less, it is easy to form the microporous membrane. From the viewpoint of obtaining a microporous membrane having a uniform pore structure, crystal of the PE crystal may preferably have a melting point of 125° C. or higher, and more preferably 130° C. or higher.

The method 400 may proceed to block 404. In block 404, polyolefin may be mixed with inorganic nanomaterials, in a high-speed dispersing machine. In some examples, a mass ratio of the polyolefin and inorganic nanomaterials may be from 10:1 to 6:1. The mixing may be performed for at least one hour to ensure that the polyethylene particles are evenly dispersed in the suspension. Once the mixing is complete, the method 400 may proceed to block 406. In block10 406, hydrocarbon liquid may be mixed into the mixture of polyolefin with inorganic nanomaterials at a higher temperature than a mixing temperature of block 402. In some examples, the hydrocarbon liquid may be paraffin oil. The temperature may be, for example, approximately 200° C. or higher. Once the mixing is complete, the method 400 may proceed to block 408. Then, in block 408, tetrabutyl titanate may be added to the solution including the mixture of polyolefin with inorganic nanomaterials. In some examples, a mass ratio of the tetrabutyl titanate and the solution may be from 1:20 to 1:15. The mixture may be stirred at high speed for approximately 0.5 hour. After mixing tetrabutyl titanate with the mixture of inorganic nanomaterials with polyolefin, the molecules of tetrabutyl titanate and polyolefin are closely bonded together. After the butyl ester is converted to titanium dioxide, the titanium dioxide particles may be evenly distributed in the mixture of inorganic nanomaterials with polyolefin structure. The dispersion of the tetrabutyl titanate molecules may become substantially uniform.

Once the mixture is mixed thoroughly, the method 400 may proceed to block 410. The mixture including tetrabutyl titanate, inorganic nanomaterials and polyolefin may be transferred to an extruder, such as a twin-screw extruder from a pump through a die. In some examples, a heating temperature of the twin-screw extruder may be set differently at different zones around 200° C. (e.g., 215° C., 225° C., 220° C., and 210° C. in extrusion film formation). The extruder may press the mixture into a film. The method 400 may proceed to block 412. In block 412, the film may be stretched. In some examples, the film may be stretched at approximately 100° C. in a processing machine direction (MD) and in a traverse direction (TD) that is 90 degrees to the MD in a plane defined by the film 200, as shown in FIG. 2A. In some examples, simultaneous bidirectional stretching may be performed at a stretching ratio of at least 5.0 times in the MD with a total stretching ratio of 25 to 50 times in the TD.

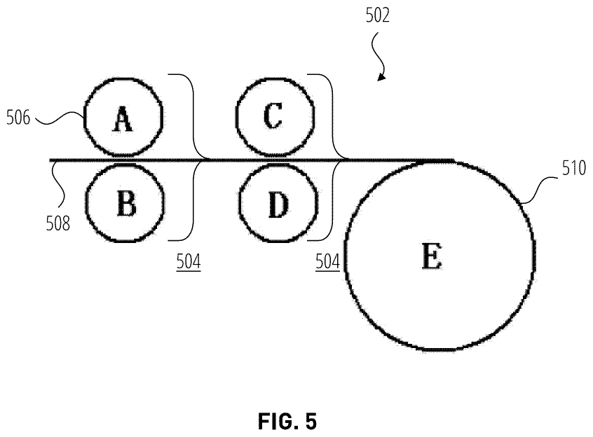

Once the film (e.g., film 508 in FIG. 5) is stretched, the method 400 may proceed to block 414. In block 414, the titanium dioxide is generated by the reaction of tetrabutyl titanate. The hydrocarbon liquid may be removed by applying a chemical material (e.g., dichloromethane). In some examples, the hydrocarbon liquid removal may be performed at room temperature. Thus, the film 508 may be extracted and pores may be produced in the film 508 after the removal. For example, the film 508 from an extraction tank passes through a circulating water tank. In some examples, a solution in the circulating water tank may be a mixture of ethanol and water. A range of a ratio of ethanol to water may be 8:1 to 12:1 or preferably 10:1 to 12:1. In some examples, ethanol as a diluent may reduce the reaction rate of tetrabutyl titanate with water, enabling the generation of structurally stable titanium dioxide particles. However, any organic liquid subject to liquid-liquid phase separation from polyethylene at 150 to 250° C. when mixed with 20% to 55% by weight of polyethylene to form a composition with a mass ratio of 100% compound may be used as a diluent. For example, phthalates such as dibutyl phthalate, dihexyl phthalate and dioctyl phthalate; aromatic ethers such as diphenyl ether and benzyl ether; as well as white oil, mineral oil and wax may be used.

The temperature of the extraction from the mixed solution is controlled at 5 to 10° C. by an ice machine. The titanic acid in the membrane system and the tetrabutyl ester molecules may react with water to produce titanium dioxide particles. The reaction of tetrabutyl titanate with water is an exothermic reaction. If the reaction is too fast or the heat cannot be taken out of the system in time, the temperature will be too high, thus it becomes risk factors for the fabrication process. The titanium dioxide particles are evenly distributed in a polyethylene network structure. The by-product butanol may be dissolved in ethanol and the solution may enter a rectification tower to be separated into butanol and ethanol water. Thus, the titanium dioxide particles may be added to the separator 108.

The method 400 may proceed to block 416. In block 416, the extracted film may be washed by going through an acetone extraction tank to remove diluent. The butanol produced by the reaction is slightly soluble in water, but miscible with ethanol, so the present invention can smoothly recover butanol. By mixing tetrabutyl titanate with the mixture of inorganic nanomaterials with polyolefin, multiple mechanical properties of the film may be enhanced.

The extractant used for the extraction and washing is acetone. The extraction device is designed as a three-tank series counter-current stepwise extraction, and the device is continuously circulated, that is, fresh acetone is continuously fed into the last tank. The extraction temperature is preferably room temperature, and the total extractant usage in the entire process is 10 to 100 times that of the diluent. Total extractant usage of 10 to 50 times that of the diluent is preferred from the viewpoint of cost savings. In order to ensure the absolute efficiency of the extraction device, total extractant usage of 15 to 50 times is preferred.

In some embodiments, the film may be further processed by heat treatment. The method 400 may proceed to block 418. In some embodiments, the heat treatment temperature may be set to approximately 125° C. The heat treatment may be performed for at least five minutes. The heat-treated film may be provided to a calendar machine. FIG. 5 is a schematic view of a calendar machine 502 according to an embodiment of the present disclosure. The calendar machine 502 may stretch a film 508 to form a thin layer or membrane by hot rolling process. In some examples, the hot rolling may be performed within a temperature range of 120 to 150° C. The rolled film may be rolled, trimmed, and/or slitted, etc. The hot rolling process preferably undergoes at least two hot rollings. In some examples, the calendar machine 502 may include two sets of hot rolling devices 504 arranged in series. Each hot rolling device 504 may include two alloy steel rollers 506 (an upper and a lower alloy steel roller 506). Such alloy steel may be heat resistant and may not be easily deformed when heated. Each alloy steel roller 506 is circulated with heat conduction oil at a rolling temperature range of 120 to 150° C., and a thickness of the film 508 may be approximately 25 μm. A gap between the two alloy steel rollers 506 of the hot rolling device 504 may be determined by the thickness of the film produced according to film specifications, as shown in FIG. 5. As shown, the film 508 may go between the first set of two (an upper and a lower) alloy steel rollers 506 (A and B) and second set of two (an upper and a lower) alloy steel rollers 506 (C and D) circulating with heat transfer oil. Then the film may be wound by a winding roller 510 (E). By this heat treatment, heat resistance performance of the film may be enhanced. Thus, LiB separators including inorganic substance filled film may be obtained.

In some embodiments, a surface of a film for a separator 108 may be additionally coated with a layer of inorganic substance after the heat treatment. Materials in the film with layers may include inorganic substances, binders and solvents. In some examples, the inorganic substance may include polyolefin. In some embodiments, polyolefin may include one or more kinds of polyolefins. The polyolefin may include, for example, PE, PP, or a copolymer containing alpha-olefins. Among these, PE may be preferred. PE may be UHMWPE, HDPE or LDPE or any combination thereof. In some embodiments, the LDPE may include LLDPE. In some examples, the binder may include polyvinylidene fluoride, polytetrafluoroethylene, polyvinylidene fluoride copolymer, other fluorine-containing resin, polyimide, polyamide, polysulfone, or propylene nitrile polymers or other polymers or any combination thereof. The binder may have better temperature resistance than temperature resistance of PE or PP. In some examples, the solvent may be one or more of ethanol, acetone, N-Methylpyrrolidone and other solvents. The solvent may dissolve the binder. For water-soluble binders, water may also be used as the solvent. The inorganic substance, binder and solvent may be mixed according to a predetermined ratio, and the mixture may be stirred well to form a uniform slurry. The ratio of inorganic substance to binder may be, for example, between 50:1 and 1:1. Then the slurry may be applied to one or both sides of the film after the heat treatment. In some examples, the slurry may be applied to have a thickness of 2 to 10 μm coating layer on one side. The coating method may be continuous or with intervals, and may be dip coating, gravure and/or other methods. In the coating layer, the inorganic substance particles may be oxides of metals such as silicon, aluminum, calcium, titanium, and barium; or nitrides of metals such as silicon, aluminum, calcium, titanium, and barium; or silicon carbide. Silica and aluminum oxide may be preferred. The particle diameter of the inorganic particles is preferably 50 nm to 5 μm, and more preferably 100 nm to 1,000 μm.

A coated LiB separator that includes a coating layer on the surface of the film may have higher porosity with pores of larger diameters in the coating layer and less porosity with pores of smaller diameters in the coating layer. By applying the coating layer, higher heat resistance of a separator with higher porosity of the film may be achieved.

In the manner described above, embodiments of a LiB having a separator including a mixture of inorganic nanomaterials with polyolefin have been described above. A LiB with a separator including a mixture of inorganic nanomaterials with polyolefin may provide reduction of heat shrinkage, enhanced porosity of the separator, improvement of porous structures, and enhancement of electrolyte retention capability. Thus, an absorption rate and/or electrolyte uptake may be increased.

Disclosed herein are various exemplary embodiments for a LiB having a separator including a mixture of inorganic nanomaterials with polyolefin. As can be appreciated by one of skill in the art, any one or more of the features, functions, and structures provided in one embodiment can be utilized in another disclosed embodiment. Thus many, if not all, of the features, functions, and structures are interchangeable with the disclosed embodiments.

This disclosure has been made with reference to various exemplary embodiments, including the best mode. However, those skilled in the art will recognize that changes and modifications may be made to the exemplary embodiments without departing from the scope of the present disclosure. While the principles of this disclosure have been shown in various embodiments, many modifications of structures, arrangements, proportions, elements, materials, and components may be adapted for a specific environment and/or operating requirements without departing from the principles and scope of this disclosure. These and other changes or modifications are intended to be included within the scope of the present disclosure.

This disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element. The scope of the present disclosure should, therefore, be determined by the following claims.

What is claimed is:

1. A lithium ion battery comprising:
a cathode configured to release lithium ions while the lithium ion battery is in a charging mode;
an anode configured to release lithium ions while the lithium ion battery is in a discharging mode;
a separator that includes one or more pores configured to transport lithium ions from a first side to a second side in the charging mode, and further configured to transport lithium ions from the second side to the first side in the discharging mode; and
electrolytes configured to carry the lithium ions released from the cathode through the separator to the anode in the charging mode, and further configured to carry the lithium ions released from the anode through the separator to the cathode in the discharging mode,
wherein the separator includes a mixture of inorganic nanomaterials with polyolefin.

2. The lithium ion battery of claim 1, wherein the separator comprises approximately from 12% to 24% of polyolefin.

3. The lithium ion battery of claim 1, wherein the polyolefin comprises at least one of polyethylene (PE) or polypropylene (PP) or amorphous poly-alpha-olefin (PAO) or a combination thereof.

4. The lithium ion battery of claim 3, wherein the polyolefin comprises high molecular PE.

5. The lithium ion battery of claim 4, wherein a range of molecular weight of the high molecular PE is approximately from 5×10⁵ to 3.5×10⁶ (grams/mol).

6. The lithium ion battery of claim 4, wherein the high molecular PE comprises at least one of extra-high molecular weight PE (UHMWPE), high density PE (HDPE) or low density PE (LDPE).

7. The lithium ion battery of claim 6, wherein the high molecular PE comprises linear low density PE (LLDPE).

8. The lithium ion battery of claim 1, wherein the separator comprises approximately from 4% to 24% of inorganic nanomaterials or nanoparticles.

9. The lithium ion battery of claim 8, wherein the inorganic nanomaterials comprise material in a form of an oxide or nitride.

10. The lithium ion battery of claim 9, wherein the inorganic nanomaterials comprise an oxide or nitride of silicon, aluminum, calcium, titanium, barium, or a combination thereof.

11. The lithium ion battery of claim 8, wherein the inorganic nanomaterials comprise metal in a form of carbonate or sulfate.

12. The lithium ion battery of claim 11, wherein the metal comprises silicon, aluminum, titanium, barium, or a combination thereof.

13. The lithium ion battery of claim 8, wherein a particle size of inorganic nanomaterials is in a range of approximately from 1 nm to 200 nm.

14. The lithium ion battery of claim 13, wherein the particle size of inorganic nanomaterials is in a range of approximately from 1 nm to 100 nm.

15. The lithium ion battery of claim 1, wherein the mixture of inorganic nanomaterials with polyolefin comprises titanium oxide.

16. The lithium ion battery of claim 1, wherein the separator comprises a coating layer.

17. A method for preparing a separator for a lithium ion battery, comprising:
mixing polyolefin with inorganic nanomaterials in a high-speed dispersing machine to provide first mixture;
mixing hydrocarbon liquid into the first mixture to provide a solution;
mixing tetrabutyl titanate into the solution to provide third mixture and stirring the third mixture at high speed; and
extruding the third mixture into a film.

18. The method of claim 17, wherein a mass ratio of the polyolefin and inorganic nanomaterials is from 10:1 to 6:1, and
wherein said mixing in the high-speed dispersing machine is performed for at least one hour.

19. The method of claim 17, wherein a mass ratio of the tetrabutyl titanate and the solution is from 1:20 to 1:15, and
wherein said stirring the third mixture at high speed is performed for approximately 0.5 hour.
